(19) United States
(12) Patent Application Publication
(10) Pub. No.: US 2024/0404030 A1
(43) Pub. Date: Dec. 5, 2024

(54) CONTEXT-DEPENDENT COLOR-MAPPING OF IMAGE AND VIDEO DATA

(71) Applicant: Dolby Laboratories Licensing Corporation, San Francisco, CA (US)

(72) Inventor: Timo KUNKEL, Kensington, CA (US)

(73) Assignee: Dolby Laboratories Licensing Corporation, San Francisco, CA (US)

(21) Appl. No.: 18/700,413

(22) PCT Filed: Sep. 28, 2022
(86) PCT No.: PCT/US2022/045050

§ 371 Date: Apr. 11, 2024

Related U.S. Application Data
(60) Provisional application No. 63/254,196, filed on Oct. 11, 2021.

(30) Foreign Application Priority Data
Oct. 11, 2021 (EP) 21201948.3

(51) Int. Cl. G06T 5/92; G06T 7/194; G06T 7/50; G06T 15/06; H04N 1/60

(52) U.S. Cl. CPC G06T 5/92; G06T 7/194; G06T 7/50; G06T 15/06; H04N 1/60; G06T 2207/10024

(57) ABSTRACT

Systems and methods for performing color mapping operations. One system includes a processor to perform post-production editing of image data. The processor is configured to identify a first region of an image and identify a second region of the image. The first region includes a first white point having a first tone, and the second region includes a second white point having a second tone. The processor is further configured to determine a color mapping function based on the first tone, apply the color mapping function to the second region of the image, and generate an output image.

### CROSS-REFERENCE TO RELATED APPLICATIONS

This application claims priority to European Patent Application No. 21201948.3, filed Oct. 11, 2021, and U.S. Provisional Patent Application No. 63/254,196, filed Oct. 11, 2021, the contents of each of which are hereby incorporated by reference in its entirety.

### BACKGROUND

### Field of the Disclosure

This application relates generally to systems and methods of image color mapping.

### Description of Related Art

Digital images and video data often include undesired noise and mismatching color tones. Image processing techniques are often used to alter images. Such imaging techniques may include, for example, applying filters, changing colors, identifying objects, and the like. Noise and mismatching colors may be the result of limitations of how display devices are depicted within the image or video data (such as a captured or photographed television) and cameras used to capture the image or video data. Ambient lighting may create undesired noise or otherwise impact the color tone of image or video data.

### BRIEF SUMMARY OF THE DISCLOSURE

Content captured with a camera may contain electronic, emissive displays that project light at a different color temperature or tone than nearby other light sources both within and outside of the frame. For example, white points within an image frame may differ in color temperature. The dynamic range and the luminance range of captured displays and the camera used to capture the image frame may differ. Additionally, the overall color volume rendition of captured displays or light sources and their reflections may differ from the camera used to capture the image frame. Accordingly, techniques for correcting color temperatures and tones within image frames have been developed. Techniques may further account for device characteristics of cameras used to capture the image frame.

Various aspects of the present disclosure relate to devices, systems, and methods for color mapping image and video data.

In one exemplary aspect of the present disclosure, there is provided a video delivery system for context-dependent color mapping. The video delivery system comprises a processor to perform post-production editing of video data including a plurality of image frames. The processor is configured to identify a first region of one of the image frames and identify a second region of the one of the image frames. The first region includes a first white point having a first tone, and the second region includes a second white point having a second tone. The processor is further configured to determine a color mapping function based on the first tone and the second tone, apply the color mapping function to the second region, and generate an output image for each of the plurality of image frames.

In another exemplary aspect of the present disclosure, there is provided a method for context-dependent color mapping of image data. The method comprises identifying a first region of an image and identifying a second region of the image. The first region includes a first white point having a first tone, and the second region includes a second white point having a second tone. The method includes determining a color mapping function based on the first tone and the second tone, applying the color mapping function to the second region of the image, and generating an output image.

In another exemplary aspect of the present disclosure, there is provided a non-transitory computer-readable medium storing instructions that, when executed by a processor of an image delivery system, cause the image delivery system to perform operations comprising identifying a first region of an image and identifying a second region of the image. The first region includes a first white point having a first tone, and the second region includes a second white point having a second tone. The operations further comprise determining a color mapping function based on the first tone and the second tone, applying the color mapping function to the second region of the image, and generating an output image.

In this manner, various aspects of the present disclosure provide for the display of images having a high dynamic range, wide color gamut, high frame rate, and high resolution, and effect improvements in at least the technical fields of image projection, image display, holography, signal processing, and the like.

### DESCRIPTION OF THE DRAWINGS

These and other more detailed and specific features of various embodiments are more fully disclosed in the following description, reference being had to the accompanying drawings, in which:

FIG. 1 depicts an example process for an image delivery pipeline.

FIG. 2 depicts an example image captured by a camera.

FIG. 3 depicts an example process for identifying light sources.

FIG. 4 depicts an example process for identifying reflections.

FIGS. 5A-5B depict example ray tracing operations.

FIG. 6 depicts an example process for a color-mapping operation.

FIG. 7 depicts the example image frame of FIG. 2 following a color-mapping operation.

FIG. 8 depicts an example content capture environment.

FIG. 9 depicts an example process for a color-mapping operation.

FIG. 10 depicts an example pipeline for performing the process of FIG. 9.

FIG. 11 depicts an example process for a color-mapping operation.

### DETAILED DESCRIPTION

This disclosure and aspects thereof can be embodied in various forms, including hardware, devices or circuits controlled by computer-implemented methods, computer program products, computer systems and networks, user interfaces, and application programming interfaces: as well as hardware-implemented methods, signal processing circuits, memory arrays, application specific integrated circuits (ASICs), field programmable gate arrays (FPGAs), and the like. The foregoing is intended solely to give a general idea of various aspects of the present disclosure, and does not limit the scope of the disclosure in any way.

In the following description, numerous details are set forth, such as optical device configurations, timings, operations, and the like, in order to provide an understanding of one or more aspects of the present disclosure. It will be readily apparent to one skilled in the art that these specific details are merely exemplary and not intended to limit the scope of this application.

### Video Coding of HDR Signals

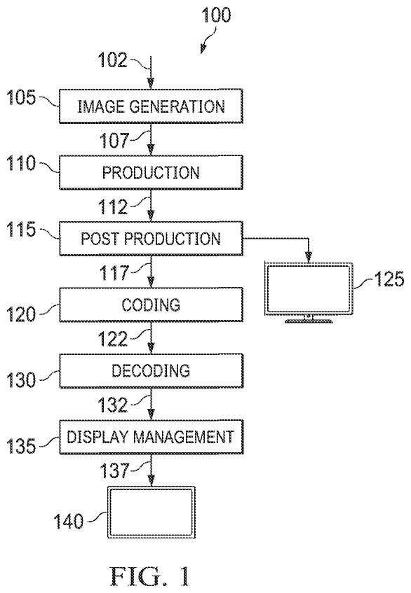

FIG. 1 depicts an example process of an image delivery pipeline (100) showing various stages from image capture to image content display. An image (102), which may include a sequence of video frames (102), is captured or generated using image generation block (105). Images (102) may be digitally captured (e.g. by a digital camera) or generated by a computer (e.g. using computer animation) to provide image data (107). Alternatively, images (102) may be captured on film by a film camera. The film is converted to a digital format to provide image data (107). In a production phase (110), image data (107) is edited to provide an image production stream (112).

The image data of production stream (112) is then provided to a processor (or one or more processors such as a central processing unit (CPU)) at block (115) for post-production editing. Block (115) post-production editing may include adjusting or modifying colors or brightness in particular areas of an image to enhance the image quality or achieve a particular appearance for the image in accordance with the image creator's creative intent. This is sometimes called “color timing” or “color grading.” Methods described herein may be performed by the processor at block (115). Other editing (e.g. scene selection and sequencing, image cropping, addition of computer-generated visual special effects, etc.) may be performed at block (115) to yield a final version (117) of the production for distribution. During post-production editing (115), the image, or video images, is viewed on a reference display (125). Reference display (125) may, if desired, be a consumer-level display or projector.

Following post-production (115), image data of final production (117) may be delivered to encoding block (120) for delivering downstream to decoding and play back devices such as computer monitors, television sets, set-top boxes, movie theaters, and the like. In some embodiments, coding block (120) may include audio and video encoders, such as those defined by ATSC, DVB, DVD, Blu-Ray, and other delivery formats, to generate coded bit stream (122). In a receiver, the coded bit stream (122) is decoded by decoding unit (130) to generate a decoded signal (132) representing an identical or close approximation of signal (117). The receiver may be attached to a target display (140) which may have completely different characteristics than the reference display (125). In that case, a display management block (135) may be used to map the dynamic range of decoded signal (132) to the characteristics of the target display (140) by generating display-mapped signal (137). Additional methods described herein may be performed by the decoding unit (130) or the display management block (135). Both the decoding unit (130) and the display management block (135) may include their own processor, or may be integrated into a single processing unit. While the present disclosure refers to a target display (140), it will be understood that this is merely an example. It will further be understood that the target display (140) can include any device configured to display or project light: for example, computer displays, televisions, OLED displays, LCD displays, quantum dot displays, cinema, consumer, and other commercial projection systems, heads-up displays, virtual reality displays, and the like.

### Method of Identifying Varying Light Temperatures

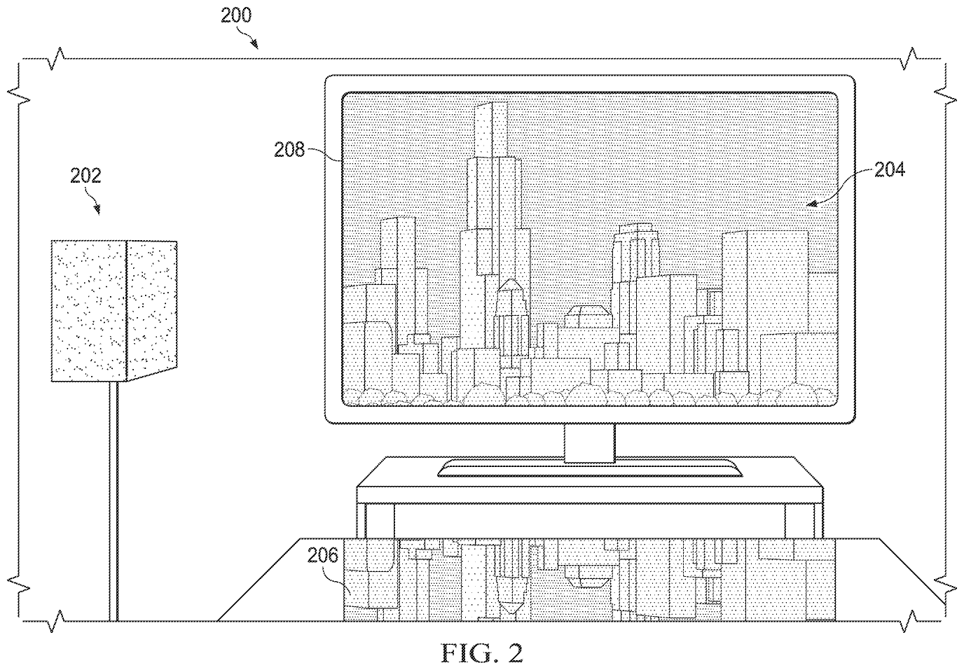

As stated above, captured images, such as image (102), may contain multiple different light sources, such as video displays (for example, televisions, computer monitors, and the like) and room illumination devices (for example, lamps, windows, overhead lights, and the like) as well as reflections of those illumination devices. The captured images may include one or more still images and one or more image frames in a video. For example, FIG. 2 provides an image frame (200) with a first light source (202) and a second light source (204). The first light source (202) and the second light source (204) may each emit a light of a different temperature (or tone). In the example of FIG. 2, the first light source (202) emits a warmer tone of light than the second light source (204). Light projected from both the first light source (202) and the second light source (204) create reflections within the image frame (200). Specifically, the second light source (204) creates reflections (206) where the light impacts an object within the image frame (200). In some implementations, the image frame (200) includes additional objects that may be impacted by light from the first light source (202), the second light source (204), or a combination thereof.

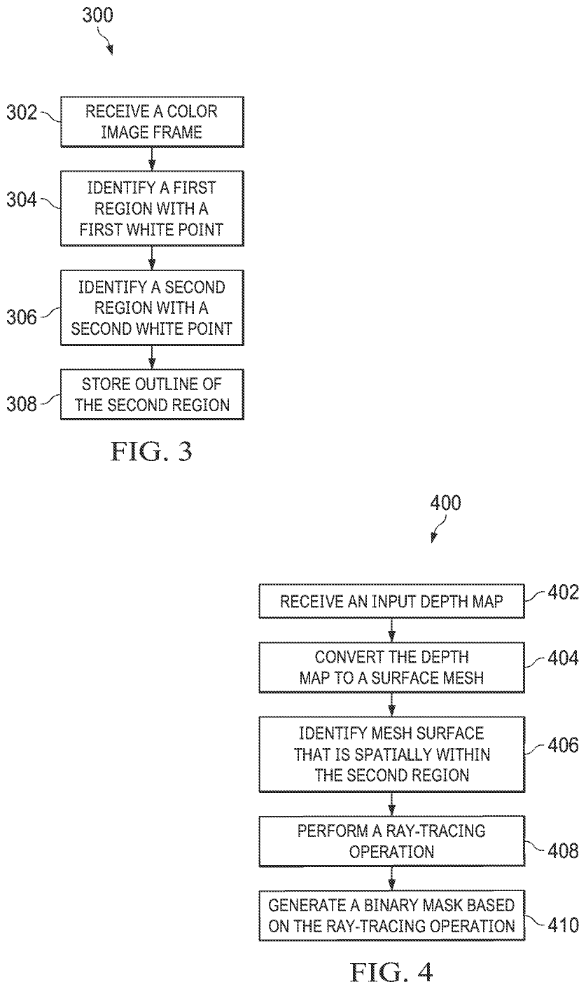

FIG. 3 provides a method (300) of identifying light sources of varying tones within an image. The method (300) may be performed by, for example, the processor at block (115) for post-production editing. At step (302), the processor receives an image, such as an image frame (200). In some implementations, upon receiving the image frame (200), the processor corrects or otherwise alters the image frame (200) to account for shading artifacts and lens geometry of the camera used to capture the image frame (200).

At step (304), the processor identifies a first region with a first white point. For example, the first light source (202) may be identified as the first region. The processor may identify a plurality of pixels having the same or similar color tone values as the first region. At step (306), the processor identifies a second region with a second white point. For example, the second light source (204) may be identified as the second region. Identification of the first region and the second region may be performed using computer vision algorithms or similar machine learning-based algorithms. In some embodiments, the processor further identifies an outline of the second region. For example, outline (or border) (208) may be identified as containing direct light emitted by the second light source (204). At step (308), the processor stores the outline, an alpha mask of, and/or other information identifying the second region.

### Methods of Identifying Light Reflections

If desired, reflections from light sources may be determined. For example, FIG. 4 provides a method (400) of identifying reflections of light sources. The method (400) may be performed by, for example, the processor at block (115) for post-production editing. At step (402), the processor receives an input depth map of the image frame (200). The depth map may be received via a light detection and ranging (LiDAR) device, radar, an acoustic radar, a machine-learned algorithm, depth from stereo images, other techniques, or a combination of these and other techniques. At step (404), the processor converts the input depth map to a surface mesh. The mesh defines spatial positions of objects within the depth map and their surface orientation. At step (406), the processor identifies points of the surface mesh located spatially within the second region. Accordingly, the object or device projecting the second light source (204) is identified. In some implementations, the processor maps the outline (208) to the surface mesh.

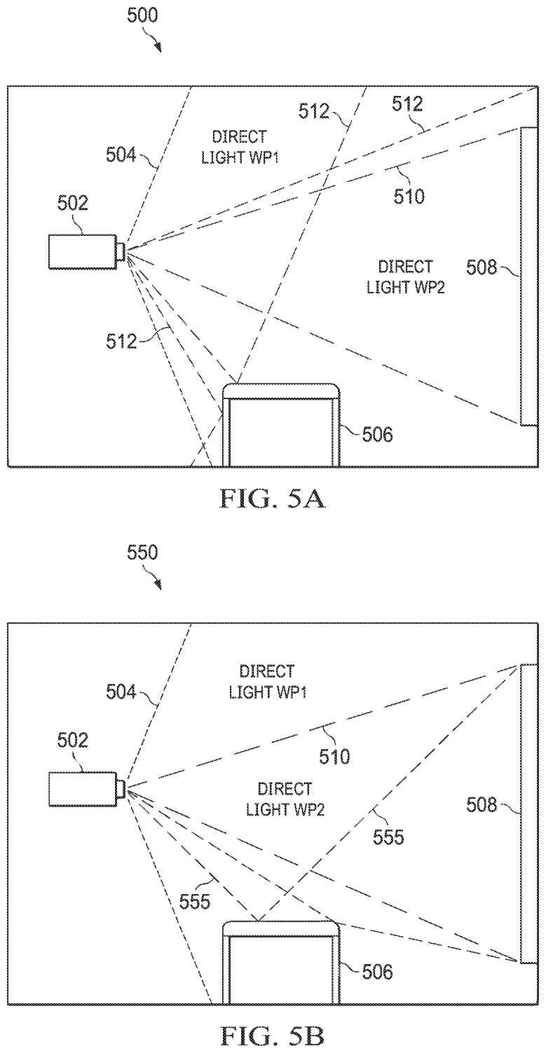

At step (408), the processor performs a ray tracing operation from the viewpoint of the camera into the scene within the image frame (200). For example, FIGS. 5A and 5B provide example ray tracing operations. FIG. 5A illustrates light WP1 (e.g., light having a first white point) projected by the first light source (202) within a first environment (500). Dotted line 504 is an outline of content within the environment (500) that is visible to a camera (502) (and therefore included in a corresponding image frame (200)). In other words, the dotted line (504) illustrates the field of view of camera 502. The content includes an object (506) and a display device (508) (such as a television). Light WP2 (e.g., light having a second white point) is directly projected by the display device (508) (e.g., the second light source (204)) into the camera (502). The dashed line (510) illustrates the portion of the field of view of camera (502) in which display device (508) appears. The solid lines (512) represent rays of light WP1 projected by the first light source (202) (not shown). The rays (512) include rays received directly from the first light source (202) and reflected rays that have already reflected off a surface. The surface normal of the object (506) may be determined based on the depth map.

FIG. 5B illustrates light projected by the second light source (204) (e.g., display device (508) within a second environment (550)). Similar to the first environment (500), dotted line (504) is an outline of content within the second environment (550) that is visible to the camera (502). Dashed line (510) identifies the outline of light projected by the display device (508) that is directly received by the camera (502). Light projected by the display device (508) towards object (506) is represented by solid lines (555). The light represented by the solid lines (555) may reflect off the object (506) prior to being received by the camera (502). The surface normal of the object (506) may be determined based on the depth map.

Reflections of light projected by the display device (508) (or otherwise some other light source such as second light source (204)) may be determined by following the light rays on the surface normals of the mesh surface identified at step (406). Should the light ray travel from the viewport camera (502), reflect off of a surface normal, and ultimately intersect with points within the outline (208) of the second light source (204), the ray is determined as a reflection of the second light source (204). At step (410), the processor generates a binary or alpha mask based on the ray-tracing operation. For example, each point of the surface map may be given a binary or alpha value based on whether a ray from the second light source (204) hits (i.e. intercepts) the respective point. Accordingly, reflections of light projected by the second light source (204) are determined. In some implementations, rather than a binary value, a probability value, or alpha value, may be given to each point of the surface map, such as a value from 1 to 10, a value of 1 to 100, a decimal value from 0) to 1, or the like. A reflection may be determined based on the probability value exceeding a threshold. For example, on a scale of 1 to 10, any value above 5 is determined to be a reflection of the second light source (204). The probability threshold may be adjusted during the post-production editing (115).

In some implementations, reflections of light projected by the second light source (204) are determined by analyzing a plurality of sequential image frames. For example, several image frames within the video data (102) may capture the same or a similar environment (such as environment 500). Within the environment and from one image frame to the next (and assuming the camera and scene are otherwise relatively static in position), changes in pixel values may be determined to result from changes in the light projected by the second light source (204). Accordingly, the processor may identify which pixels within subsequent image frames change in value. These changing pixels may be used to identify the outline (208). Additionally, the processor may observe which pixels within subsequent image frames change in value that are outside of the outline (208) to determine reflections of the second light source (204).

### Method of Color Reshaping

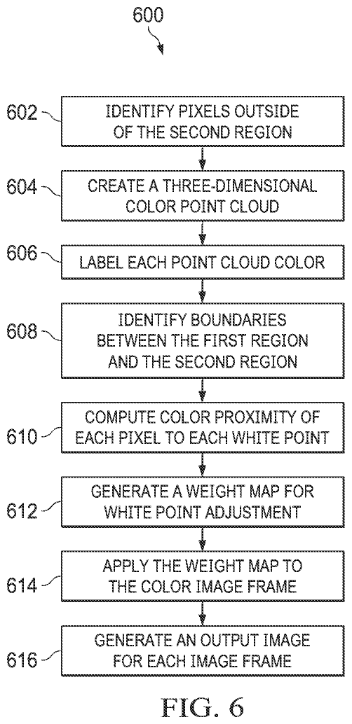

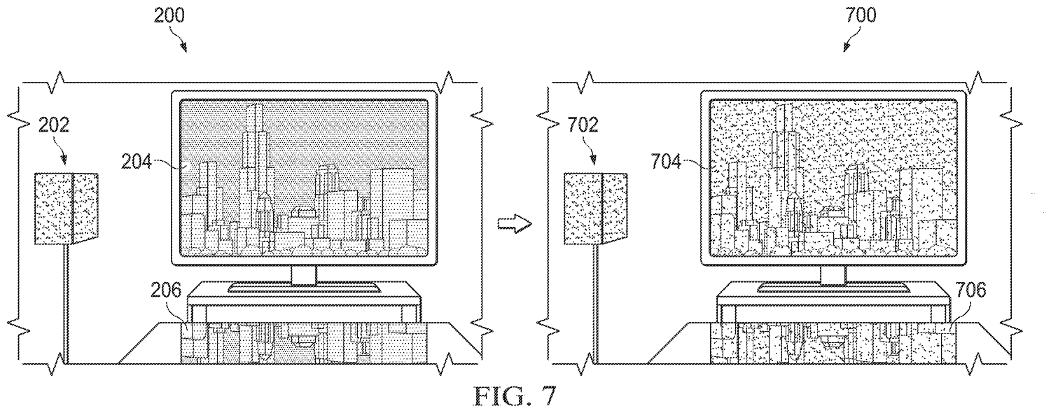

Following identifying the first and second region and obtaining the binary or alpha mask, the processor performs a color-mapping operation to adjust the color tone of the second region and its corresponding reflections. FIG. 6 provides a method (600) for performing a color reshaping operation. The method (600) may be performed by, for example, the processor at block (115) for post-production editing. At step (602), the processor identifies pixels outside of the second region. For example, the processor identifies outside of the outline 208. At step (604), the processor creates a three-dimensional color point cloud. For example, the processor creates a color volume in ICtCp color space, CIELAB color space, or the like. At step (606), the processor labels each point within the color point cloud based on the results from the ray tracing operation performed in step (408). For example, each point within the color point cloud may be labelled as “WP1” (e.g., being part of or within the first region, the first white point, the first light source (202), etc.), “WP2 direct” (e.g., being direct or immediate reflections from the second light source (204)), or “WP2 indirect” (e.g., being indirect or secondary reflections from the second light source (204)).

At step (608), the processor identifies boundaries between the first region and the second region. These boundaries define the color value (such as R, G, and B values) used to determine whether a pixel is labeled as WP1 or WP2. In some embodiments, the color boundaries are determined using a cluster analysis operation, such as k-means clustering. In cluster analysis, several algorithms may be used to group sets of objects that are similar to each other. In k-means clustering, each pixel is provided as a vector. An algorithm takes each vector and represents each cluster of pixels by a single mean vector. Other clustering methods may be used, such as hierarchical clustering, biclustering, a self-organizing map, and the like. The processor may use the result of the cluster analysis to confirm the accuracy of the ray-tracing operation.

At step (610), the processor computes the color proximity of each pixel to each white point. For example, the value of each pixel labelled “WP2 direct” or “WP2 indirect” is compared to the value of the second white point and the value of the k-means boundary identified at step (608). The value of each pixel labelled “WP1” is compared to the value of the first white point and the value of the k-means boundary identified at step (608). At step (612), the processor generates a weight map for white point adjustment. For example, each pixel with a color proximity distance between the first white point and the k-means boundary that is less than a distance threshold (for example, 75%) receives no white point adjustment (e.g., a weight value of 0.0). Each pixel with a color proximity distance between the second white point and the k-means boundary that is less than the distance threshold receives a full white point adjustment (e.g., a weight value of 1.0). Pixels between these distance threshold values are weighted between the first white point and the second white point (e.g., a value between 0.0 and 1.0) to avoid harsh color boundaries.

After generating the weight map, the pixels within the outline (208) are given a weight value of 1.0 for full white point adjustment. At step (614), the processor applies the weight map to the image frame (200). For example, any pixel with a weight value of 1.0 is color-mapped to a color tone similar to that of the first white point. Any pixel with a weight value between 0.0 and 1.0 is color-mapped to a color tone between the first white point and the second white point. Accordingly, both the second light source (204) and reflections of the second light source (204) experience a color tone adjustment to matched or be similar to the tone of the first light source (202). At step (616), the processor generates an output image for each image frame (200) of the video data (102). In some implementations, the output image is the image frame (200) with the applied weight map. In other implementations, the output image is the image frame (200), and the weight map is provided as metadata. FIG. 7 provides an exemplary second image frame (700) that is a color-mapped version of the image frame (200). As shown in the second image frame (700), the mapped second light source (704) and mapped reflections (706) have experienced a tone adjustment compared to the second light source (204) and reflections (206) of the image frame (200).

In some implementations, the amount of tone adjustment of the second light source (204) is dependent on the location of the corresponding pixel and a gradient of the image frame (200). For example, following labelling each point within the color point cloud based on the results from the ray tracing operation (at step (606)), the processor may compute boundary masks indicating how far each pixel in the image frame (200) is from the outline (208). For example, a mask mₑₓₚ may be an alpha mask indicative of how likely a pixel is part of the first light source (202). A mask m_{cont} may be an alpha mask of how likely a pixel is part of the second light source (204), or is a reflection of the second light source (204). The masks mₑₓₚ and m_{cont} are determined with respect to a source mask mₛ, or the output of step (606). Specifically, mₑₓₚ is a mask of pixels expanding beyond (or away from) the outline (208) of the second light source (204), and m_{cont} is a mask of pixels contracting within the outline (208), or towards a center of the second light source (204).

Following the determination of mₑₓₚ and m_{cont}, the processor creates a weight map for white point adjustment. The weight map is based on both the distance from each pixel to the outline (208), as provided by the masks mₑₓₚ and m_{cont}, and the surface normal gradient change between the masks mₑₓₚ and m_{cont}. In some implementations, to determine the surface normal gradient change m_{Gradient}, the processor observes m_{exp,xy}, M_{cont,xy}, and m_{s,vy}, or the corresponding mask value for a given pixel (x,y). If m_{s,xy} is equal to 1 and m_{cont,xy} is not equal to 1, the processor determines with a high certainty (e.g., approximately 100% certain) that the pixel (x,y) is related to the second light source (204), and m_{Gradient,xy} is given a value of 1, resulting in a full white point adjustment for the pixel (x,y). If m_{s,xy} is equal to 0) and m_{exp,xy} is not equal to 1, the processor determines with a high certainty that the pixel (x,y) is related to the first light source (202), and m_{Gradient,xy} is given a value of 0), resulting in no white point adjustment for the pixel (x,y). For pixels falling between these ranges, the processor identifies a surface gradient change between the individual pixels of mₑₓₚ and m_{cont} based on the surface normal of each pixel (from step (404) to step (408)). The alpha mask m_{Gradient} is weighted based on the surface gradient change such that pixels (x,y) with a lower gradient change receive a greater amount of white point adjustment, and pixels (x,y) with a greater gradient change receive less white point adjustment. In some implementations, predetermined thresholds may be used by the processor to determine values of m_{Gradient}. For example, pixels may be weighted linearly for any value of gradient change between 2% and 10%. Accordingly, any pixels with less than 2% gradient change are given a value of 1, and any pixel with greater than 10% gradient change are given a value of 0). These thresholds may be altered during post-production editing based on user input.

In some implementations, to determine the distance from each pixel to the outline (208), the boundary defined by outline (208) is determined as the “center”, and a distance mask m_{Distance} has a value of 0.5 for pixels directly on the outline (208). For pixels that are spatially towards m_{exp.xy} (i.e., away from the center of the second light source (204)), the value of m_{Distance} decreases. For example, the pixel (x,y) that is one pixel away from the outline (208) may have an m_{Distance} of 0.4, the pixel (x,y) that is two pixels away from the outline (208) may have an m_{Distance} value of 0.3, and so on. Alternatively, for pixels that are spatially towards m_{cont.vy} (i.e., towards the center of the second light source (204)), the value of m_{Distance} increases. For example, the pixel (x,y) that is one pixel away from the outline (208) may have an m_{Distance} of 0.6, the pixel (x,y) that is two pixels away from the outline (208) may have an m_{Distance} value of 0.7, and so on. The rate at which m_{Distance} increases or decreases may be altered during post-production editing based on user input.

The final alpha mask m_{Final} used for white point adjustment may be based on m_{Gradient} and m_{Distance}. Specifically, m_{Gradient} and m_{Distance} may be multiplied to generate the final alpha mask m_{Final}. Use of m_{Final} results in a smoothing of the spatial boundaries between the second light source (204) and any background light created by first light source (202). However, if the surface gradient change between the second light source (204) and pixels beyond the outline (208) is very large, the final alpha mask m_{Final} may not smooth the adjustment between these pixels, and the variance between the pixels may be maintained. In some implementations, to avoid harsh spatial boundaries between pixels, the weight map generated at step (612), or alternatively the weight map m_{Final}, may be blurred via a Gaussian convolution. The convolution kernel of the Gaussian convolution may have different parameters based on whether pixels are within the second light source (204) or are reflections (206).

In some implementations, an amount of color-mapping performed by the processor may be altered by a user. For example, the post-production block (115) may provide for a user to adjust the color tone of the mapped second light source (704). In some implementations, the user selects the color tone of the mapped second light source (704) and mapped reflections (706) by moving a tone slider. The tone slider may define a plurality of color tones between the color tone of the first light source (202) and the second light source (204). In some implementations, the user may select additional color tones beyond those similar to the first light source (202) and the second light source (204). The user may adjust values of the weight map or values of the binary or alpha mask directly. Additionally, a user may directly select the second light source (204) within the image frame (200) by directly providing the outline (208). Additionally, a user may adjust color proximity distance thresholds for determining whether pixels are given a full white point adjustment (e.g., a weight value of 1.0), an intermediate white point adjustment (e.g., a weight value between 0.0 and 1.0), or is given no white point adjustment.

In some implementations, ambient light from the first light source (202) may bounce off the second light source (204) itself and create reflections (e.g. as mostly global, diffuse, or Lambertian ambient reflection) within the display of the second light source (204). In such an instance, the weight map may weigh the pixels labeled “WP1” to the second white point as a function of the pixel luminance or relative brightness of the second light source (204). This can be facilitated or implemented by adding a global weight to all the pixels “WP2”. Accordingly, the overall image tonal impact of the second light source (204) may be reduced. Additionally, this global weight can be modulated by the luminance or brightness of the pixels labeled “WP2”. Dark pixels are more likely to be affected by “WP1” through diffuse reflection of the display screen while bright pixels are representing the active white point of the display (“WP2”).

The weight map and the binary or alpha mask may be provided as metadata included with the coded bit stream (122). Accordingly, rather than performing the color-mapping at the post-production block (115), color-mapping map be performed by the decoding unit (130) or a processor associated with the decoding unit (130). In some implementations, a user may receive the weight map as metadata and manually change the tone color or values of the weight map after decoding of the coded bit stream (122).

In implementations where the second light source (204) is a display device (such as display device (508)), the processor may identify content shown on the display device. Specifically, the processor may determine that the content provided on the display device is stored in a server related to the video delivery pipeline (100). Techniques for such determination may be found in U.S. Pat. No. 9,819,974, “Image Metadata Creation for Improved Image Processing and Content Delivery,” which is incorporated herein by reference in its entirety. The processor may then retrieve the content from the server and replace the content shown on the display device within the image frame (200) with the content from the server. The content with the server may be of a higher resolution and/or higher dynamic range. Accordingly, details lost from the image frame (200) may be re-obtained via such replacement. In some implementations, rather than replacing the entire content shown on the display, the processor identifies differences between the content shown on the display and the content stored in the server. The processor then adds or replaces only the identified differences. Additionally, in some implementations, noise may be added back into the replaced content. The amount of noise may be set by a user or determined by the processor to maintain realism between the surrounding content of the image frame (200) and the replaced content. A machine learning program or other algorithm optimized to improve or alter the dynamic range of existing video content may also be applied.

### Dynamic Color Mapping

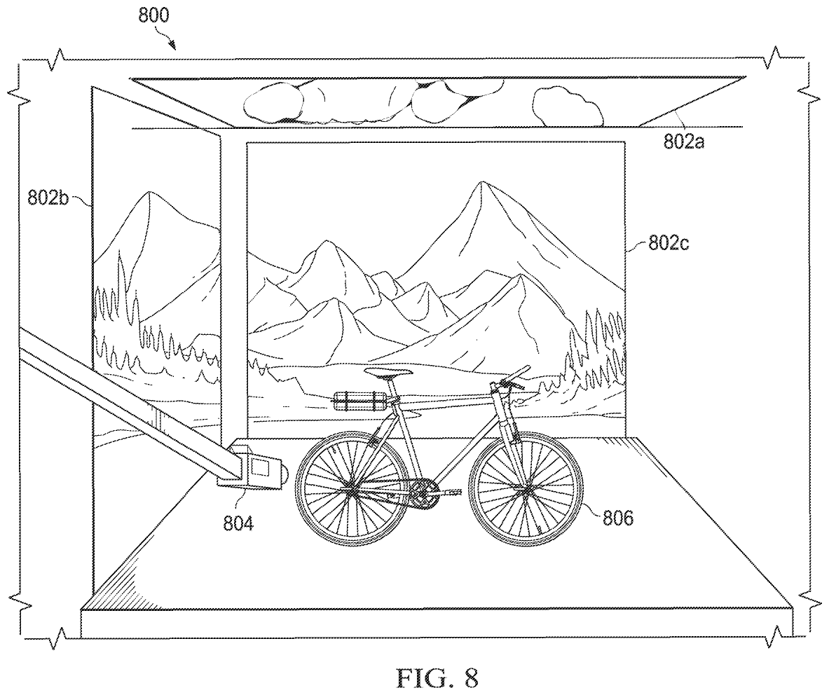

Content production is increasingly using active displays, such as light emitting diode (LED) walls, to display a background in real time. Accordingly, a portion of or even an entire filming environment may be composed of display devices. FIG. 8 provides an example filming environment (800) composed of a plurality of display devices (802) (such as, for example, a first display 802a, a second display 802b, and a third display 802c) and a camera 804). However, the luminance range of the plurality of display devices (802) and/or the capabilities of camera (804) may be unable to reach the extremes required for HDR content production. For example, maximum luminance limits in the plurality of display devices (802) may be too low for production such that, when combined with additional scene illumination from outside the captured scene, the captured footage appears dull or otherwise unrealistic. The luminance range of the plurality of display devices (802) may also differ from the capabilities of the camera (804), creating a difference between the quality of content provided on the plurality of display devices (802) and content captured by the camera (804).

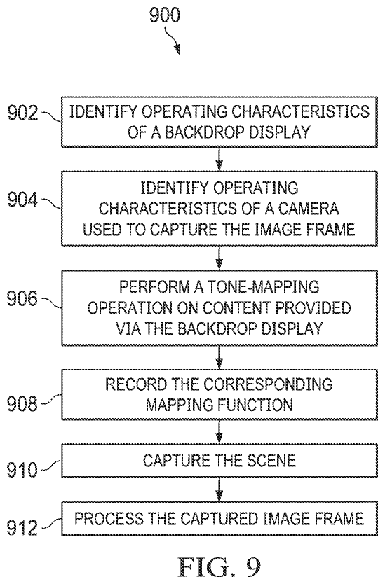

FIG. 9 provides a method (900) for performing a color-mapping operation within a filming environment, such as the filming environment (800). The method (900) may be performed by, for example, the processor at block (115) for post-production editing. At step (902), the processor identifies operating characteristics of a backdrop display, such as the plurality of display devices (802). For example, the processor may identify spectral emission capability of the backdrop display and viewing angular properties of the backdrop display, such as angular dependency. These may assist in identifying how color and luminance of the backdrop display changes based on the capture angle of the image. At step (904), the processor identifies operating characteristics of a camera used to capture the filming environment (800), such as the camera (804). The operating characteristics of the camera (804) may include, for example, a spectral transmittance of the lens, vignetting of the lens, shading of the lens, fringing of the lens, spectral sensitivity of the camera, light sensitivity of the camera, and the signal-to-noise ratio (SNR) (or dynamic range) of the camera, and the like. The operating characteristics of the plurality of display devices (802) and the operating characteristics of the camera (804) may both be identified based on metadata retrieved by the processor.

At step (906), the processor performs a tone-mapping operation on content provided via the backdrop display. Tone-mapping the content fits the content to the operating characteristics of, and therefore the limitations of, the plurality of display devices (802) and the camera (804). In some implementations, the tone-mapping operation includes clipping tone-detail in some pixels to achieve higher luminance. This may match the signal provided by the plurality of display devices (802) with the signal captured by the camera (804). At step (908), the processor records the corresponding map function. For example, the map function of the tone-mapping operation is stored as metadata such that a downstream processor can invert the tone-curved map of the captured image.

At step (910), the processor captures the scene using the camera (804) to generate an image frame (200). At step (912), the processor processes the image frame (200). For example, the processor may receive a depth map of the filming environment (800). The processor may identify reflections of light within the filming environment (800), as described with respect to method (400). However, illumination sources may be present beyond the viewport of the camera (804). In some implementations, these illumination sources may be known by the processor and used for viewpoint adjustment. Alternatively, illumination beyond the viewport of the camera (804) may be accessible using a mirror ball. The camera (804) and/or the processor may determine the origination of any light in the filming environment (800) using the mirror ball. Illumination beyond the viewport of the camera (804) may also determined using LiDAR capture or similar techniques. For example, a test pattern may be provided on each of the plurality of display devices (802). Any non-display light source is turned on to provide illumination. With the illumination on and the test pattern displayed, the filming environment (800) is scanned using LiDAR capture. In this manner, the model of the filming environment (800) captured by the camera (804) may be brought into the same geometric world-view as the depth map from the point of view of the camera (804).

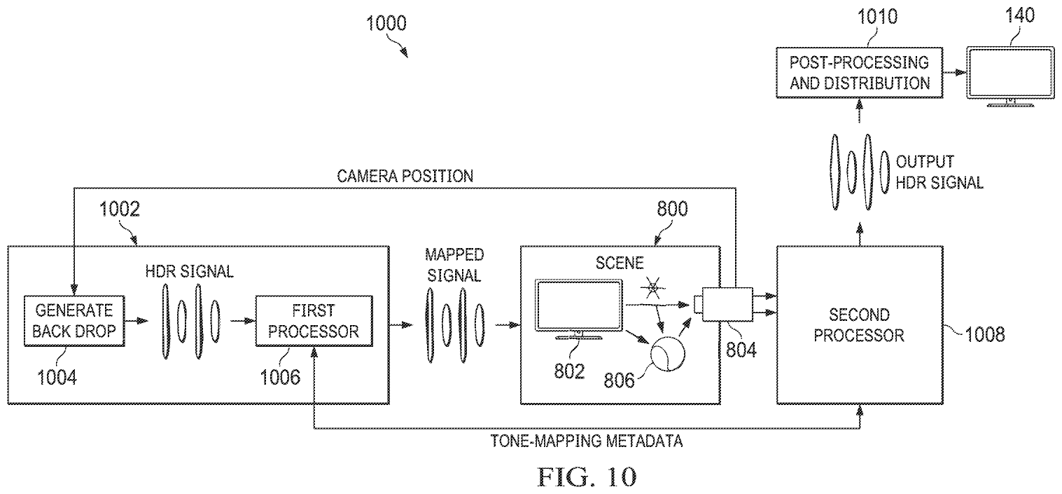

FIG. 10 provides an exemplary pipeline (1000) capable of performing the method (900). Additionally, the pipeline (1000) provides a process for adding or altering content provided on a backdrop display during post-production editing. A backdrop renderer (1002) generates the backdrop content at block (1004). The backdrop content is an HDR signal provided to a first processor (1006). The first processor (1006) performs the tone-mapping operation on the HDR signal to map the HDR signal to the physical limits of the backdrop display, such as the plurality of display devices (802). Metadata describing the tone-mapping process may be provided from the first processor (1006) to a second processor (1008). The mapped HDR signal is then provided on the plurality of display devices (802) within the filming environment (800). The camera (804) captures the filming environment (800), including content provided via the display devices (802), objects (806) within the filming environment (800), and ambient light provided to and reflected within the filming environment (800).

The second processor (1008) receives the captured filming environment (800) and a depth map of the filming environment (800). The second processor (1008) performs operations described with respect to method (900), including detecting world geometry of the filming environment (800), identifying reflections of light within the filming environment (800), determining and applying the inverse of the tone-mapping function, and determining characteristics of the camera (804) and the plurality of display devices (802). An output HDR signal for viewing the content captured by the camera (804) is provided to a post-processing and distribution block (1010), which provides the content to the target display (140).

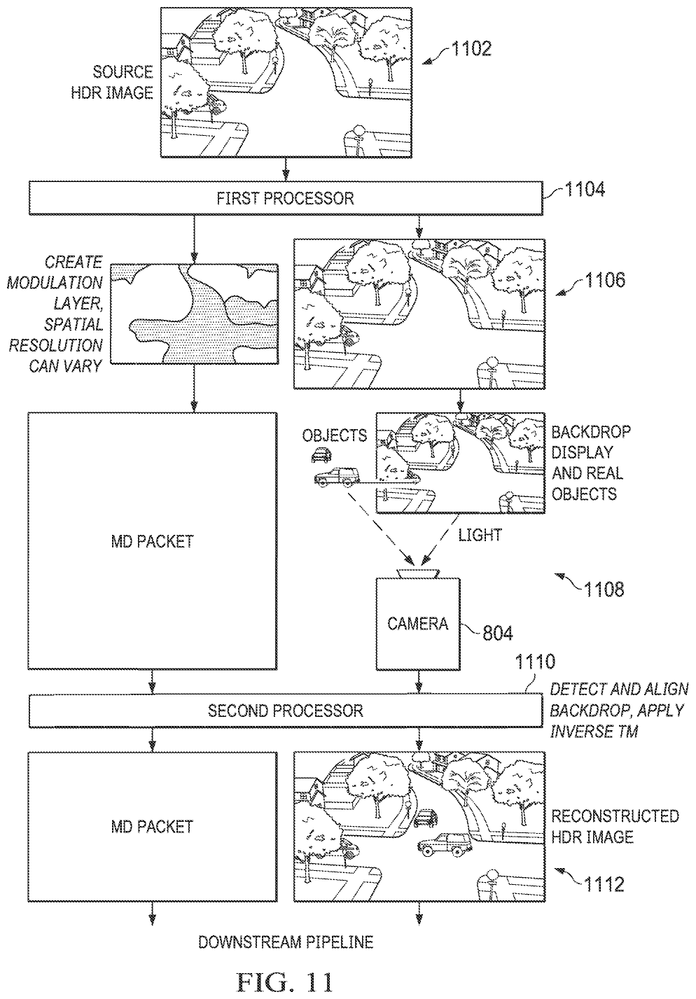

While method (900) describes a global tone-mapping function (e.g., a single tone curve for the plurality of display devices (802)), a local tone-mapping function may also be used. FIG. 11 illustrates a process (1100) for applying spatial weighting to the tone-mapping function. A source HDR image (1102) is provided to a first processor (1104). The first processor (1104) separates the source HDR image (1102) separated into a foreground layer and a modulation layer at step (1106). Separation may be achieved via dual modulation light field algorithms (such as the ones used with the Dolby Professional Reference Monitor or from dual layer encoding algorithms) or other invertible local tone mapping operators. The “reduced” image is then provided via the plurality of display devices (802) at step (1108). The filming environment (800) is captured by the camera (804), and both the captured video data and the modulation layer are provided to a second processor (1110). The second processor (110) detects the content provided via the plurality of display devices (802) and applies the inverse tone-mapping function. The reconstructed HDR video data and the modulation layer are then provided to the downstream pipeline at step (1112).

Temporal compensation may also be used when performing the previously-described color-mapping operations. For example, content provided via the plurality of display devices (802) may vary over the course of the video data. These changes over time may be recorded by the first processor (1006). As one example, changes in luminance levels of content provided by the plurality of display devices (802) may be processed by the processor (1006), but only slight changes in illumination are provided by the plurality of display devices (802) during filming. Following capture of the filming environment (800), the intended illumination changes are “placed into” the video data during post-processing. As another example, “night shots” or night illumination may be simulated during post-processing to retain sufficient scene illumination.

Other lighting preference settings or appearances may also be implemented.

Non-display light sources, such as matrix light emitting display (LED) devices and the like, may also be implemented in the filming environment (800). Off-screen fill and key lights may be controlled and balanced to avoid over-expansion of video data after capture. The post-production processor (115) may balance diffuse reflections on real objects in the filming environment (800) against highlights that are directly reflected. For example, reflections may be from glossy surfaces such as eyes, wetness, oily skin, or the like. Additionally, on-screen light sources that are directly captured by the camera (804) may be displayed via the plurality of display devices (802). The on-screen light sources may then be tone-mapped and reverted to their intended luminance after capture.

The above video delivery systems and methods may provide for luminance adjustment based upon a viewer adaptation state. Systems, methods, and devices in accordance with the present disclosure may take any one or more of the following configurations.

(1) A video delivery system for context-dependent color mapping, the video delivery system comprising: a processor to perform post-production editing of video data including a plurality of image frames. The processor is configured to: identify a first region of one of the image frames, the first region including a first white point having a first tone, identify a second region of the one of the image frames, the second region including a second white point having a second tone, determine a color mapping function based on the first tone and the second tone, apply the color mapping function to the second region, and generate an output image for each of the plurality of image frames.

(2) The video delivery system according to (1), wherein the processor is further configured to: receive a depth map associated with the one of the image frames, and convert the depth map to a surface mesh.

(3) The video delivery system according to (2), wherein the processor is further configured to: perform a ray tracing operation from a camera viewpoint of the one of the image frames using the surface mesh, and create a binary mask based on the ray tracing operation, wherein the binary mask is indicative of reflections of the first white point and the second white point.

(4) The video delivery system according to any one of (2) to (3), wherein the processor is further configured to: generate a surface normal gradient change alpha mask for the one of the image frames based on the surface mesh, generate a spatial distance alpha mask for the one of the image frames, and determine the color mapping function based on the surface normal gradient change alpha mask and the spatial distance alpha mask.

(5) The video delivery system according to any one of (1) to (4), wherein the processor is further configured to: create a three-dimensional color point cloud for the background image, and label each point cloud pixel.

(6) The video delivery system according to any one of (1) to (5), wherein the processor is further configured to: determine, for each pixel in the one of the image frames, a distance between a value of the pixel, the first tone, and the second tone.

(7) The video delivery system according to any one of (1) to (6), wherein the second region is a video display device, and wherein the processor is further configured to: identify a secondary image within the second region, receive a copy of the secondary image from a server, wherein the copy of the secondary image received from the server has at least one of a higher resolution, a higher dynamic range, or a wider color gamut than the secondary image identified within the second region, and replace the secondary image within the second region with the copy of the secondary image.

(8) The video delivery system according to any one of (1) to (7), wherein the processor is further configured to: determine operating characteristics of a camera associated with the video data and determine operating characteristics of a backdrop display, wherein the color mapping function is further based on the operating characteristics of the camera and the operating characteristics of the backdrop display.

(9) The video delivery system according to any one of (1) to (8), wherein the processor is further configured to: subtract the second region from the one of the image frames to create a background image, identify a change in value for at least one pixel in the background image over subsequent image frames, and apply, in response to the change in value, the color mapping function to the at least one pixel in the background image.

(10) The video delivery system according to any one of (1) to (9), wherein the processor is further configured to: perform a tone-mapping operation on second video data displayed via a backdrop display, record a mapping function based on the tone-mapping operation, and apply an inverse of the mapping function to the one of the image frames.

(11) The video delivery system according to any one of (1) to (10), wherein the processor is further configured to: identify a third region of the one of the image frames, the third region including reflections of a light source defined by the second region, and apply the color mapping function to the third region.

(12) The video delivery system according to any one of (1) to (11), wherein the processor is further configured to: store the color mapping function as metadata, and transmit the metadata and the output image to an external device.

(13) A method for context-dependent color mapping image data, the method comprising: identifying a first region of an image, the first region including a first white point having a first tone, identifying a second region of the image, the second region including a second white point having a second tone, determining a color mapping function based on the first tone and the second tone, applying the color mapping function to the second region of the image, and generating an output image.

(14) The method according to (13), further comprising: identifying a third region of the image, the third region including reflections of a light source defined by the second region, and applying the color mapping function to the third region.

(15) The method according to any one of (13) to (14), further comprising: receiving a depth map associated with the image, and converting the depth map to a surface mesh.

(16) The method according to (15), further comprising: performing a ray tracing operation from a camera viewpoint of the one of the image frames using the surface mesh, and creating a binary mask based on the ray tracing operation, wherein the binary mask is indicative of reflections of the first white point and the second white point.

(17) The method according to any one of (15) to (16), further comprising: generating a surface normal gradient change alpha mask for the image based on the surface mesh, generating a spatial distance alpha mask for the image, and determining the color mapping function based on the surface normal gradient change alpha mask and the spatial distance alpha mask.

(18) The method according to any one of (13) to (17), further comprising: subtracting the second region from the image to create a background image, creating a three-dimensional color point cloud for the background image, and labeling each point cloud pixel.

(19) The method according to any one of (13) to (18), further comprising: determining operating characteristics of a camera associated with the image data and determining operating characteristics of a backdrop display, wherein the color mapping function is further based on the operating characteristics of the camera and the operating characteristics of the backdrop display.

(20) A non-transitory computer-readable medium storing instructions that, when executed by an electronic processor, cause the electronic processor to perform operations according to any one of (13) to (19).

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments incorporate more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

Various aspects of the present invention may by appreciated from the following enumerated example embodiments (EEEs):

EEE 1. A video delivery system for context-dependent color mapping, the video delivery system comprising:
a processor to perform post-production editing of video data including a plurality of image frames, the processor configured to:
   identify a first region of one of the image frames, the first region including a first white point having a first tone;
   identify a second region of the one of the image frames, the second region including a second white point having a second tone:
   determine a color mapping function based on the first tone and the second tone;
   apply the color mapping function to the second region; and
   generate an output image for each of the plurality of image frames.
      EEE 2. The video delivery system of EEE 1, wherein the processor is further configured to:
receive a depth map associated with the one of the image frames; and
convert the depth map to a surface mesh.
   EEE 3. The video delivery system of EEE 2, wherein the processor is further configured to:
perform a ray tracing operation from a camera viewpoint of the one of the image frames using the surface mesh; and
create a binary mask based on the ray tracing operation, wherein the binary mask is indicative of reflections of the first white point and the second white point.
   EEE 4. The video delivery system of EEE 2 or 3, wherein the processor is further configured to:
generate a surface normal gradient change alpha mask for the one of the image frames based on the surface mesh;
generate a spatial distance alpha mask for the one of the image frame; and
determine the color mapping function based on the surface normal gradient change alpha mask and the spatial distance alpha mask.
   EEE 5. The video delivery system of any one of EEEs 1 to 4, wherein the processor is further configured to:
create a three-dimensional color point cloud for the one of the image frames; and
label each point cloud pixel.
   EEE 6. The video delivery system of any one of EEEs 1 to 5, wherein the processor is further configured to:
determine, for each pixel in the one of the image frames, a distance between a value of the pixel, the first tone, and the second tone.
   EEE 7. The video delivery system of any one of EEEs 1 to 6, wherein the second region is a video display device, and wherein the processor is further configured to:
identify a secondary image within the second region;
receive a copy of the secondary image from a server, wherein the copy of the secondary image received from the server has at least one of a higher resolution, a higher dynamic range, or a wider color gamut than the secondary image identified within the second region; and
replace the secondary image within the second region with the copy of the secondary image.
   EEE 8. The video delivery system of any one of EEEs 1 to 7, wherein the processor is further configured to:
determine operating characteristics of a camera associated with the video data; and
determine operating characteristics of a backdrop display,
wherein the color mapping function is further based on the operating characteristics of the camera and the operating characteristics of the backdrop display.
   EEE 9. The video delivery system of any one of EEEs 1 to 8, wherein the processor is further configured to:
subtract the second region from the one of the image frames to create a background image;
identify a change in value for at least one pixel in the background image over subsequent image frames; and
apply, in response to the change in value, the color mapping function to the at least one pixel in the background image.
   EEE 10. The video delivery system of any one of EEEs 1 to 9, wherein the processor is further configured to:
perform a tone-mapping operation on second video data displayed via a backdrop display;
record a mapping function based on the tone-mapping operation; and
apply an inverse of the mapping function to the one of the image frames.
   EEE 11. The video delivery system of any one of EEEs 1 to 10, wherein the processor is further configured to:
identify a third region of the one of the image frames, the third region including reflections of a light source defined by the second region; and
applying the color mapping function to the third region.
   EEE 12. The video delivery system of any one of EEEs 1 to 11, wherein the processor is further configured to:
store the color mapping function as metadata; and
transmit the metadata and the output image to an external device.
   EEE 13. A method for context-dependent color mapping image data, the method comprising:
identifying a first region of an image, the first region including a first white point having a first tone;
identifying a second region of the image, the second region including a second white point having a second tone;
determining a color mapping function based on the first tone and the second tone;
applying the color mapping function to the second region of the image; and
generating an output image.
   EEE 14. The method of EEE 13, further comprising:
identifying a third region of the image, the third region including reflections of a light source defined by the second region; and
applying the color mapping function to the third region.
   EEE 15. The method of EEE 13 or 14, further comprising:
receiving a depth map associated with the image; and
converting the depth map to a surface mesh.
   EEE 16. The method of EEE 15, further comprising:
performing a ray tracing operation from a camera viewpoint of the image using the surface mesh; and
creating a binary mask based on the ray tracing operation, wherein the binary mask is
indicative of reflections of the first white point and the second white point.
   EEE 17. The method of EEE 15 or 16, further comprising:
generating a surface normal gradient change alpha mask for the image based on the surface mesh;
generating a spatial distance alpha mask for the image; and
determining the color mapping function based on the surface normal gradient change alpha mask and the spatial distance alpha mask.
   EEE 18. The method of any one of EEEs 13 to 17, further comprising:
subtracting the second region from the image to create a background image;
creating a three-dimensional color point cloud for the background image; and
labeling each point cloud color pixel.
   EEE 19. The method of any one of EEEs 13 to 18, further comprising:
determining operating characteristics of a camera associated with the image data; and
determining operating characteristics of a backdrop display,
wherein the color mapping function is further based on the operating characteristics of the camera and the operating characteristics of the backdrop display.
   EEE 20. A non-transitory computer-readable medium storing instructions that, when executed by an electronic processor, cause the electronic processor to perform operations comprising the method of any one of EEEs 13 to 20.
   EEE 21. The video delivery system of any one of EEEs 1 to 12, wherein the processor is further configured to:
create a color point cloud in a three-dimensional color space for the one of the image frames; and
label each point cloud pixel.
   EEE 22. The video delivery system of EEE 5 or 21, wherein the processor is configured to label
each point cloud pixel within the color point cloud based on the results from the ray tracing operation.
   EEE 23. The video delivery system of any one of EEEs 5, 21, or 22, wherein the label indicates if the pixel is identified as being in the first in the first region or in the second region.
   EEE 24. The video delivery system of EEE 6, wherein the processor is configured to determine the distance between the value of the pixel, the first tone, and the second tone based on one or more of a label of the pixel and a boundary between color regions.
   EEE 25. The video delivery system of EEE 8, wherein the camera associated with the video data is a camera used when capturing the video data and/or a camera used to capture the video data.
   EEE 26. The video delivery system of EEE 8 or 25, wherein at least a portion of the second region of the one of the image frames represents at least a portion of the backdrop display.
   EEE 26. The video delivery system of any one of EEEs 1 to 12 or 21-24, wherein the processor is further configured to:
create a background image from one of the image frames based on the second region, such as based on a difference between the second region and the first region;
identify a change in value for at least one pixel in the background image over subsequent image frames; and
apply, in response to the change in value, the color mapping function to the at least one pixel in the background image.
   EEE 27. The video delivery system of any one of EEEs 1 to 12 or 21-26, wherein the processor is further configured to:
perform a tone-mapping operation on second video data provided to a backdrop display, potentially to be displayed via the backdrop display;
record a mapping function based on the tone-mapping operation; and
apply an inverse of the mapping function to the one of the image frames.

1. A video delivery system for context-dependent color mapping, the video delivery system comprising:
a processor to perform post-production editing of video data including a plurality of image frames, the processor configured to:
identify a first region of one of the image frames, the first region including a first white point having a first tone;
identify a second region of the one of the image frames, the second region including a second white point having a second tone;
determine a color mapping function based on the first tone and the second tone;
apply the color mapping function to the second region; and
generate an output image for each of the plurality of image frames.

2. The video delivery system of claim 1, wherein the processor is further configured to:
receive a depth map associated with the one of the image frames; and
convert the depth map to a surface mesh.

3. The video delivery system of claim 2, wherein the processor is further configured to:
perform a ray tracing operation from a camera viewpoint of the one of the image frames using the surface mesh; and
create a binary mask based on the ray tracing operation, wherein the binary mask is indicative of reflections of the first white point and the second white point.

4. The video delivery system of claim 2, wherein the processor is further configured to:
generate a surface normal gradient change alpha mask for the one of the image frames based on the surface mesh;
generate a spatial distance alpha mask for the one of the image frame; and
determine the color mapping function based on the surface normal gradient change alpha mask and the spatial distance alpha mask.

5. The video delivery system of claim 1, wherein the processor is further configured to:
create a three-dimensional color point cloud for the one of the image frames; and
label each point cloud pixel.

6. The video delivery system of claim 1, wherein the processor is further configured to:
determine, for each pixel in the one of the image frames, a distance between a value of the pixel, the first tone, and the second tone.

7. The video delivery system of claim 1, wherein the second region is a video display device, and wherein the processor is further configured to:
identify a secondary image within the second region;
receive a copy of the secondary image from a server, wherein the copy of the secondary image received from the server has at least one of a higher resolution, a higher dynamic range, or a wider color gamut than the secondary image identified within the second region; and
replace the secondary image within the second region with the copy of the secondary image.

8. The video delivery system of claim 1, wherein the processor is further configured to:
determine operating characteristics of a camera associated with the video data; and
determine operating characteristics of a backdrop display,
wherein the color mapping function is further based on the operating characteristics of the camera and the operating characteristics of the backdrop display.

9. The video delivery system of claim 8, wherein the camera associated with the video data is a camera used to capture the video data, and wherein at least a portion of the second region of the one of the image frames represents at least a portion of the backdrop display.

10. The video delivery system of claim 1, wherein the processor is further configured to:
subtract the second region from the one of the image frames to create a background image;
identify a change in value for at least one pixel in the background image over subsequent image frames; and
apply, in response to the change in value, the color mapping function to the at least one pixel in the background image.

11. The video delivery system of claim 1, wherein the processor is further configured to:
perform a tone-mapping operation on second video data displayed via a backdrop display;
record a mapping function based on the tone-mapping operation; and
apply an inverse of the mapping function to the one of the image frames.

12. The video delivery system of claim 1, wherein the processor is further configured to:
identify a third region of the one of the image frames, the third region including reflections of a light source defined by the second region; and
applying the color mapping function to the third region.

13. The video delivery system of claim 1, wherein the processor is further configured to:
store the color mapping function as metadata; and
transmit the metadata and the output image to an external device.

14. A method of context-dependent color mapping, the method comprising:
with a processor, editing video data including a plurality of image frames by:
identifying a first region of one of the image frames, the first region including a first white point having a first tone;
identifying a second region of the one of the image frames, the second region including a second white point having a second tone;
determining a color mapping function based on the first tone and the second tone;
applying the color mapping function to the second region; and
generating an output image for each of the plurality of image frames.

15. A non-transitory computer-readable medium storing instructions that, when executed by an electronic processor, cause the electronic processor to perform operations comprising the method of claim 14.
